(19) United States
(12) Patent Application Publication
(10) Pub. No.: US 2023/0361327 A1
(43) Pub. Date: Nov. 9, 2023

(54) POWER GENERATION CONTROL DEVICE

(71) Applicant: KABUSHIKI KAISHA TOYOTA CHUO KENKYUSHO, Nagakute-shi, Aichi-ken (JP)

(72) Inventors: Takao WATANABE, Nagakute-shi (JP); Norihiro FUKAYA, Nagakute-shi (JP); Ryoichi HIBINO, Nagakute-shi (JP)

(73) Assignee: KABUSHIKI KAISHA TOYOTA CHUO KENKYUSHO, Nagakute-shi, Aichi-ken (JP)

(21) Appl. No.: 18/026,444

(22) PCT Filed: Sep. 21, 2021
(86) PCT No.: PCT/JP2021/034594

§ 371 Date: Mar. 15, 2023

(30) Foreign Application Priority Data
Nov. 19, 2020 (JP) 2020-192842

(51) Int. Cl. H01M 8/04858; H01M 8/04537

(52) U.S. Cl. CPC H01M 8/04947; H01M 8/04932; H01M 8/04611; H01M 8/04626

(57) ABSTRACT

An operation mode of a secondary battery (BAT) is determined based on state of charge of BAT. A power generation provisional command value of fuel cell (FC) at time i is determined to maximize efficiency of FC based on system required power and state of charge of BAT at time i. An intermittent ON/OFF state at time i is determined such that switching of intermittent operation of FC is not continuous based on operation mode of BAT, the power generation provisional command value, and the system required power at time i, and an intermittent ON/OFF state at time (i−1). Further, when intermittent ON is determined at time i, the FC is stopped, and when intermittent OFF is determined at time i, a larger one is output, as the power generation command value for the FC at time i, between the power generation provisional command value and an intermittent OFF threshold.

### FIELD OF THE INVENTION

The present invention relates to a power generation control device, and more particularly, a power generation control device used. to control a fuel cell system including a fuel cell (SC) that generates power and a secondary battery (BAT) that stores surplus power.

### BACKGROUND OF THE INVENTION

A hybrid vehicle refers to an automobile that has two or more power sources (for example, a fuel cell and a secondary battery). The hybrid vehicle is characterized by higher fuel efficiency than ordinary vehicles with a single power source because it can use different power sources depending on a situation. In the hybrid vehicle, however, it is necessary to appropriately distribute the power sources depending on the situation in order to further improve fuel efficiency.

On the other hand, in a hybrid vehicle having a fuel cell as one of the power sources, when power distribution is performed with priority to efficiency, the fuel cell is usually frequently repeated between an operation (ON) state and a suspension (OFF) state. When such intermittent control is performed on the fuel cell, a catalyst in the fuel cell is repeatedly exposed to a high potential state and a low potential state, resulting in deterioration of the catalyst.

To solve such a problem, therefore, various proposals have been made in the past. For example, Patent Literature 1 discloses the following methods for a fuel cell system for a mobile object, which includes a fuel cell, a power storage device, and a control device that controls the two:
(a) a method of decreasing a threshold for transition from a power generation suspension mode to a normal power generation mode as the speed of the moving object increases, and
(b) a method of controlling a voltage between terminals of the fuel cell such that the voltage does not exceed the upper voltage limit (lower than open circuit voltage) when an operating state of the fuel cell is in the power generation suspension mode.

Patent Literature 1 describes that
(A) if the threshold is set smaller as speed of a moving object is higher, the fuel cell can be shifted to a normal power generation mode at an earlier timing than when the threshold is not changed, making it possible to suppress deterioration of responsiveness and drivability of the fuel cell being intermittently operated, and that
(B) the upper potential limit in the power generation suspension mode is preferably set to a level at which a platinum catalyst in the fuel cell is not eluted.

The method described in Patent Literature 1 can be used to suppress deterioration of the catalyst in the fuel cell, while suppressing deterioration of responsiveness thereof. However, even when the method described in Patent Literature 1 is used, frequency of intermittent control may increase in a case of a driving pattern or a vehicle, in which required output tends to vary across the intermittent operation threshold, leading to deterioration of the durability of the fuel cell. On the other hand, if the intermittent operation switching frequency is simply reduced to improve durability of the fuel cell, the charge/discharge amount of the secondary battery increases, leading to reduction in fuel efficiency.

Further, for a fuel cell system including a fuel cell that generates electric power and a secondary battery that stores surplus electric power, there has been no proposal of a power generation control device that can improve durability of the fuel cell without reducing fuel efficiency.

### CITATION LIST

### Patent Literature

[Patent Literature 1] Japanese Unexamined Patent Application Publication No. 2011-014465

### SUMMARY OF THE INVENTION

The problem to be solved by the present invention is to provide a power generation control device for a fuel cell system including a fuel cell that generates power and a secondary battery that stores surplus power, the power generation control device being capable of improving durability of the fuel cell without reducing fuel efficiency.

To solve the problem, a power generation control device according to the present invention has the following configuration.

(1) The power generation control device is used for power generation control of a fuel cell system including a fuel cell (FC) for generating power and a secondary battery (BAT) for storing surplus power.

(2) The power generation control device includes
an operation mode determination means that determines an operation mode f_SOC(i) of the BAT based on a state of charge SOC(i−1) of the BAT at time (i−1) and a state of charge SOC(i) of the BAT at time i,
a provisional command value calculation means that determines a power generation provisional command value p_fc_temp(i) of the FC at time i so as to maximize efficiency of the fuel cell system based on system required power p_req(i) at the time i and the state of charge SOC(i) of the BAT at the time i,
an intermittent state determination means that determnes an intermittent ON/OFF state f_IM(i) at the FC at the time i to avoid continuous switching of the intermittent state of the FC based on the operation mode f_SOC(i) of the BAT, the p_fc_temp(i), the p_req(i) at the time i, and an intermittent ON/OFF state f_IM(i−1) of the FC at the time (i−1); and
a power generation command value calculation means that stops (OFF) the FC when intermittent ON is determined at time i, and outputs a larger one, as a power generation command value p_fc(i) for the FC at time i, between the p_fc_temp(i) and an intermittent OFF threshold TP_IMOFF intermittent OFF is determined at time i.

The power generation control device of the present invention may further include a coverage factor calculation means that calculates a ratio (coverage factor θ(i)) of an oxide film on a fuel cell cathode catalyst at time i, and
the intermittent state determination means may further include a threshold changing means that changes the intermittent OFF threshold TP_IMOFF and/or the intermittent ON threshold TP_IMON using the coverage factor θ(i).

When the system required power p_req(i) varies, switching of the intermittent ON/OFF state is performed at an optimal timing such that switching of the intermittent state of the fuel cell is not continuous, making possible to minimize deterioration of the cathode catalyst.

In the case of power distribution between the fuel cell and the secondary battery, if power is distributed to maximize efficiency of the fuel cell system (i.e., the power generation provisional command value p_fc_temp(i) is determined to maximize the efficiency of the fuel cell system), reduction in fuel efficiency can also be suppressed. Further, when the SOC state is also used to control intermittent ON/OFF, the contradiction of SOC controllability deterioration is also eliminated, and the adverse effect of the reduction in fuel efficiency can be eliminated.

When the fuel cell is operated, and when the larger one of the power generation provisional command value p_fc_temp(i) and the intermittent OFF threshold value TP_IMOFF is selected as the power generation command value p_fc(i) of the fuel cell at time i, the fuel cell is maintained in a high load (low potential) state for a relatively long time. As a result, catalyst deterioration can be suppressed.

Further, the intermittent OFF threshold TP_IMOFF and/or the intermittent ON threshold TP_IMON are changed according to the coverage factor θ(i) of the cathode catalyst, making it possible to perform low load (high potential) operation with priority to efficiency when θ(i) is large, and high-load (low-potential) operation with priority to protection of the catalyst when θ(i) is small. As a result, it is possible to achieve improvement in efficiency together with suppression of deterioration.

### BRIEF DESCRIPTION OF THE DRAWINGS

FIG. 1 is a block diagram of a power generation control device according to a first embodiment of the present invention.

FIG. 2 is a flowchart of a process by an intermittent state determination means of the first embodiment of the present invention.

FIG. 3 is a continuation of the flowchart of FIG. 2.

FIG. 4 is a block diagram of a power generation control device according to a second embodiment of the present invention.

FIG. 5 is a block diagram of an example of a coverage factor calculation means.

FIG. 6 is a flowchart of a process by an intermittent state determination means of the second embodiment of the present invention.

FIG. 7 is a continuation of the flowchart of FIG. 6.

FIG. 8A is a temporal change in FC generation power P_{FC} according to a control method of a comparative example 1.

FIG. 8B is a temporal change in FC cell voltage V_{FC} according to the control method of the comparative example 1.

FIG. 9A is a temporal change in FC generation power P_{FC} according to a control method of an example 1.

FIG. 9B is a temporal change in FC cell voltage V_{FC} according to the control method of the example 1.

### DETAILED DESCRIPTION OF THE PREFERRED EMBODIMENTS

Hereinafter, one embodiment of the present invention be described in detail.

### 1. POWER GENERATION CONTROL DEVICE (1)

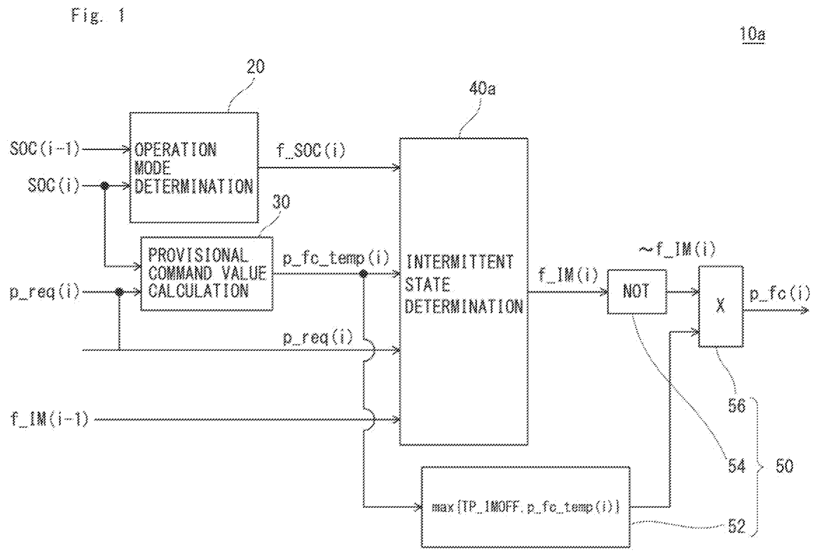

FIG. 1 illustrates a block diagram of a power generation control device according to a first embodiment of the present invention. In FIG. 1, the power generation control device 10a is used for power generation control of a fuel cell system including a fuel cell (FC) (not shown) that generates power and a secondary battery (BAT) (not shown) that stores surplus power (including regenerative energy), and includes an operation mode determination means 20, a provisional command value calculation means 30, an intermittent state determination means 40a, and a power generation command value calculation means 50.

### 1.1. Operation Mode Determination Means

The operation mode determination means 20 is a means that determines an operation mode f_SOC(i) of the BAT based on a state of charge SOC(i−1) of the BAT at time (i−1) and a state of charge SOC(i) of the BAT at time i.

Specifically, the operation mode determination means 20 is a means that sequentially compares SOC(i−1) with SOC(i) at appropriate time intervals, and determines an operation mode, in which the BAT is one of a charge mode, a discharge mode, and a normal mode (mode in which neither charge nor discharge is performed). In this case, an optimum time interval can be selected without limitation as the time interval for obtaining a state of charge of the BAT or another variable according to a purpose. The optimum time interval depends on application of the fuel cell system. For example, when the fuel cell system is used as an on-board power source, the time interval is typically 1 to 100 msec.

When the state of charge is decreasing (SOC(i−1)>SOC(i)) as a result of comparing SOC(i−1) with SOC(i), the operation mode determination means 20 determines that the BAT is in the discharge mode, and sets the flag f_SOC(i) representing the operation mode of BAT at time i to store a numerical value (for example, “1”) representing “discharge mode”.

On the other hand, when the state of charge is increasing (SOC(i−1)<SOC(i)), the operation mode determination means 20 determines that the BAT is in the charge mode, and sets the flag f_SOC(i) to store a numerical value (for example, “2”) representing “charge mode”.

Further, when the state of charge does not increase or decrease (SOC(i−1)=SOC(i)), the operation mode determination means 20 determines that the BAT is in the normal mode, and sets the flag f_SOC(i) to store a numerical value (for example, “0”) representing “normal mode”.

The flag f_SOC(i) obtained in this way is used by the intermittent state determination meant 40a to determine whether the FC should be operated (set to intermittent OFF state) or stopped (set to intermittent ON state).

### 1.2. Provisional Command Value Calculation Means

The provisional command value calculation means 30 is a means that determines a power generation provisional command value (p_fc_temp(i)) of the FC at time i so as to maximize efficiency of the fuel cell system based on system required power p_req(i) at time i and the state of charge SOC(i) of the BAT at time i.

The provisional command value calculation means 30 may be a means that consider only p_req(i) and determine the power generation provisional command value p_fc_temp(i) of the FC at time i to maximize efficiency of the fuel cell system.

Alternatively, the provisional command value calculation means 30 may be a means that consider the state of charge of the BAT in addition to pre_req(i) and determine the power generation provisional command value p_fc_temp(i) of the FC at time i such that efficiency of the fuel cell system is maximized, and the state of charge of the BAT falls between the upper SOC limit and the lower SOC limit.

In the latter case, there is a high possibility that the state of charge of the BAT will come to the SOC center and that any increase or decrease in the system required power p_req(i) can be offset by charge and discharge of the BAT. As a result, the latter method can reduce intermittent frequency of the FC more than the former method.

Any method is usable as a method for determining the power generation provisional command value p_fc_temp(i) as long as the method provides the above-described functions. The method for determining the p_fc_temp(i) is described in detail later.

The resultant p_fc_temp(i) is used by the intermittent state determination means 40a to determine whether the FC should be operated (set to intermittent OFF state) or stopped (set to intermittent ON state). In addition, the p_fc_temp(i) is used by the power generation command value calculation means 50 to determine the power generation command value p_fc(i) for the FC.

### 1.3. Intermittent State Determination Means

The intermittent state determination means 40a is a means that determines an intermittent ON/OFF state f_IM(i) of the FC at time i such that switching of the intermittent state of the FC is not continuous based on the operation mode f_SOC(i) of the BAT, the power generation provisional command value p_fc_temp(i), the system required power p_req(i) at time i, and the intermittent ON/OFF state f_IM(i−1) of the FC at time (i−1).

In other words, the intermittent state determination means 40a is a means that suppresses the switching frequency of the ON/OFF state of the FC in an appropriate manner (to the extent that the FC is not deteriorated) such that when the system required power p_req(i) varies, variations in p_req(i) are offset as much as possible by charge and discharge of the BAT.

The phrase “switching of the intermittent state of the FC is not continuous” means that:
(a) in the case where the FC is in the operating state (intermittent OFF state), even when the system required power p_req(i) crosses zero from a positive value to a negative value, the intermittent OFF state is not switched to the intermittent ON state if a predetermined condition is met (e.g., when the system required power p_req(i) is likely to vary near zero crossing); and/or
(b) when the FC is in the stopped state (intermittent ON state), even when the system required power p_req(i) crosses zero from a negative value to a positive value, the intermittent ON state is not switched to the intermittent OFF state if a predetermined condition is met (e.g., when the coverage factor θ(i) is small).

For example, when the FC is in the stopped state (intermittent ON state) at time (i−1), the intermittent state determination means 40a sets the flag f_IM(i−1) representing the intermittent ON/OFF state of the FC to store a numerical value (for example, “1”) representing “intermittent ON”.

On the other hand, if the FC is in the operating state (intermittent OFF state) at time (i−1), the intermittent state determination means 40a sets the flag f_IM(i−1) to store a numerical value (for example, “0”) representing “intermittent OFF”.

If the system required power p_req(i) varies in this state, and when it is determined that the variations can be offset by charge and discharge of the BAT instead of ON/OFF switching of the FC, the intermittent state determination means 40a sets the flag f_IM(i) representing the ON/OFF state of the FC at time i to store the same numerical value as in the flag f_IM(i−1).

On the other hand, if the variations in the p_req(i) cannot be offset only by the charge and discharge of the BAT and it is determined that the FC operation mode needs to be changed, the intermittent state determination means 40a sets the flag f_IM(i) to store a numerical value different from that in the flag f_IM(i−1).

Any method is usable as a method for determining the flag f_IM(i) as long as the method provides the above-described functions. The method for determining the flag f_IM(i) is described in detail later.

The resultant flag f_IM(i) is used by the power generation command value calculation means 50 to determine the power generation command value p_fc(i) for the FC.

### 1.4. Power Generation Command Value Calculation Means

The power generation command value calculation means 50 is a means that stops (OFF) the FC when intermittent ON is determined at time i, and outputs a larger one, as the power generation command value p_fc(i) for the FC at time i, between the p_fc_temp(i) and the intermittent OFF threshold TP_IMOFF when intermittent OFF is determined at time i.

The term “intermittent OFF threshold TP_IMOFF” refers to the threshold of the power generation provisional command value p_fc_temp(i) when the FC is shifted from the intermittent ON state (FC stopped state) to the intermittent OFF state (FC operating state). An optimum value can be selected without limitation as the value of the TP_IMOFF according to a purpose.

In FIG. 1, the power generation command value calculation means 50 includes:
a power limiting circuit 52 that outputs a larger one of the p_fc_temp(i) and the TP_IOFF;
a NOT circuit 54 that outputs a flag ˜f_IM(i) opposite to the flag f_IM(i); and
a multiplier circuit 56 that multiplies the output of the power limiting circuit 52 by the output of the NOT circuit 54.

For example, assume that the numerical value representing “intermittent ON (FC stopped)” is “1” and the numerical value representing “intermittent OFF (FC operating)” is “0”. In this case, when the flag f_IM(i) is “1”, that is, when the intermittent state determination means 40a issues a command to stop (OFF) the FC, the NOT circuit 54 outputs “0” as the flag ˜f_IM(i). As a result, the power generation command value calculation means 50 outputs zero as the p_fc(i).

On the other hand, when the flag f_IM(i) is “0”, that is, when the intermittent state determination means 40a issues a command to operate (ON) the FC, the NOT circuit 54 outputs “1” as the flag ˜f_IM(i). As a result, the power generation command value calculation means outputs, as the p_fc(i), the larger one of the p_fc_temp(i) and the TP_IMOFF.

If the larger one of the p_fc_temp(i) and the TP_IMOFF is selected as the power generation command value p_fc(i) for the FC at time i when the FC is operated, a period where the FC is maintained in a high load (low potential) state is relatively long, and excessive potential variaton is suppressed. As a result, catalyst deterioration can he suppressed.

The resultant power generation command value p_fc(i) is sent to a control device (not shown) that controls the FC, and the operation of the FC is controlled such that actual output of the FC is p_fc(i).

In this case, when the system required power p_req(i) is larger than the p_fc(i), power corresponding to a difference between them is supplied from the BAT. On the other hand, when the p_req(i) is smaller than the p_fc(i), power corresponding to a difference between them is stored in the BAT.

### 2. SPECIFIC EXAMPLE OF INTERMITTENT STATE DETERMINATION MEANS (1)

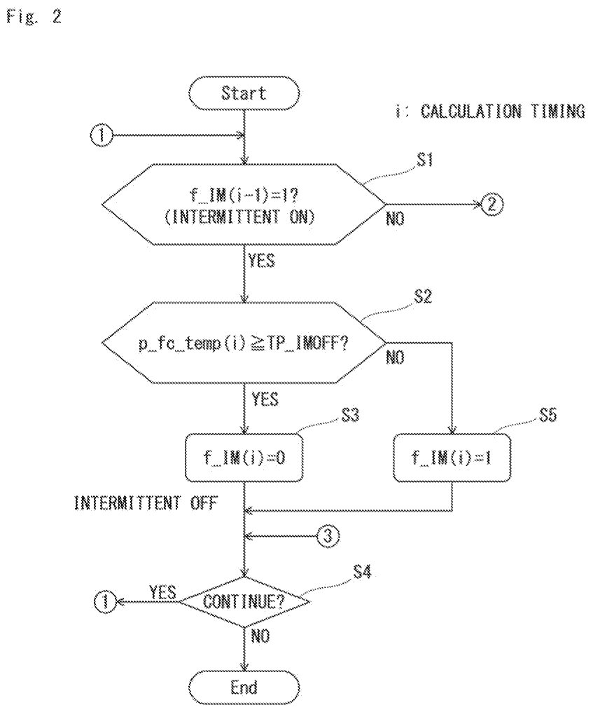

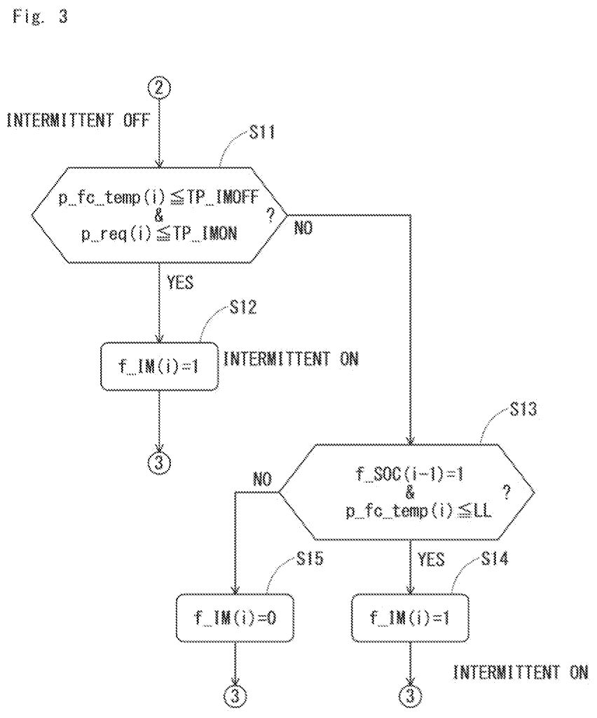

FIG. 2 illustrates a flowchart of a process by the intermittent state determination means according to the first embodiment of the present invention. FIG. 3 illustrates a continuation of the flowchart of FIG. 2.

### 2.1. First Switching Means

First, in step 1 (hereinafter simply referred to as “S1”), it is determined whether the FC is in the intermittent ON state (FC stopped state) at time (i−1), i.e., whether the flag f_IM(i−1) representing the intermittent ON/OFF state of the FC at time (i−1) is 1. If the FC is in the intermittent ON state at time (i−1) (S1: YES), the process proceeds to S2.

In S2, it is determined whether the FC power generation provisional command value p_fc_temp(i) at time i determined by the provisional command value calculation means 30 is equal to or larger than the intermittent OFF threshold TP_IMOFF. If the p_fc_temp(i) is equal to or larger than the TP_IMOFF (S2: YES), the system required power p_req(i) is relatively large, meaning that the power discharged from the BAT alone cannot cover the p_req(i). In such a case, the process proceeds to S3, and “0” is stored in the flag f_IM(i). That is, the intermittent ON state is switched to the intermittent OFF state (FC operating state) at time i (first switching means). After that, the process proceeds to S4.

On the other hand, if the p_fc_temp(i) is smaller than the TP_IMOFF (S2: NO), the system required power p_req(i) is relatively small, meaning that only the power discharged from the BAT can cover the p_req(i). In such a case, the process proceeds to S5 and “1” is stored in the flag f_IM(i). That is, the FC is maintained in the intermittent ON state (FC stopped state). After that, the process proceeds to S4.

In S4, whether to continue the control is determined. If the control is continued (S4: YES), the process returns to S1 and the steps S1 to S5 are repeated.

### 2.2. Second Switching Means

In S1, if the FC is not in the intermittent ON state at time (i−1) (S1: NO), the process proceeds to S11 in FIG. 3. In S11, it is determined whether the p_fc_temp(i) is smaller than or equal to the TP_IMOFF and the p_req(i) is smaller than or equal to the intermittent ON threshold TP_IMON.

The term “intermittent ON threshold TP_IMON” refers to the threshold of system required power p_req(i) when the FC is shifted from the intermittent OFF state (FC operating state) to the intermittent ON state (FC stopped state). An optimum value can be selected without limitation as the value of the TP_IMON according to a purpose.

The phrase “the p_fc_temp(i) is smaller than or equal to the TP_IMOFF, and the p_req(i) is smaller than or equal to the TP_IMON” means that the p_req(i) is sufficiently small and the p_req(i) can be covered only by charge and discharge of the BAT. In such a case (S11: YES), the process proceeds to S12, and “1” is stored in the flag f_IM(i). Specifically, the intermittent OFF state is switched to the intermittent ON state (FC stopped state) at time i (second switching means).

The TP_IMON may be a positive value or a negative value. For example, when the FC-BAT hybrid system is in a regenerative mode, the p_req(i) is formally a negative value. In this case, when the TP_IMON is a positive value, the condition p_req(i)≤TP_IMON is easily met, so that the operation mode of the FC switches from ON to OFF immediately. As a result, the operating mode of the FC may switch every time the hybrid system enters a weak regenerative mode, increasing frequency of intermittent operation.

On the other hand, if a negative value is used as the TP_IMON, the FC operating mode switches from ON to OFF only when the hybrid system enters a strong regenerative mode (e.g., when the fuel cell vehicle is travelling on a long downhill slope). As a result, the frequency of intermittent operation can be reduced in some cases.

### 2.3. Third Switching Means

In S11, if the p_fc_temp(i) is larger than the TP_IMOFF and/or if the p_req(i) is larger than the TP_IMON (S11: NO), the process proceeds to S13.

In S13, it is determined whether the BAT is in the discharge mode at time (i−1) and the p_fc_temp(i) is equal to or smaller than an output lower limit (LL) of the FC.

The term “output lower limit (LL)” refers to a lower limit of the power generation provisional command value p_fc_temp(i) when the intermittent OFF state (FC operating state) is switched to the intermittent ON state (FC stopped state). An optimum value can be selected without limitation as the value of the LL according to a purpose. For example, the LL may be zero or a positive value close to zero.

The phrase “the BAT is in the discharge mode (f_SOC(i−1)=1) at time (i−1), and the p_fc_temp(i) is equal to or smaller than the LL” means that the FC is substantially not operating while operating in the system and is in a state where the p_req(i) can be covered only by charge and discharge of the BAT. In such a case (S13: YES), the process proceeds to S14, and “1” is stored in the flag f_IM(i). In other words, the intermittent OFF state is switched to the intermittent ON state (FC stop state) at time i (third switching means). After that, the process returns to S4.

On the other hand, in a certain case, the BAT is not in the discharge mode (f_SOC(i−1)=1) at time (i−1) and/or the p_fc_temp(i) is more than the LL, which means that although the p_fc_temp(i) and/or the p_req(i) are relatively small, the output from the FC is substantially required. If the FC is stopped in such a case, the p_fc_temp(i) and/or the p_req(i) may increase rapidly immediately afterwards. In such a case (S13: NO), the process proceeds to S15, and “0” is stored in the flag f_IM(i). In other words, the intermittent OFF state (FC operating state) is maintained. After that, the process returns to S4.

The above steps S1 to S5 and S11 to 515 are then repeated until the control is stopped (S4: NO).

### 3. POWER GENERATION CONTROL DEVICE (2)

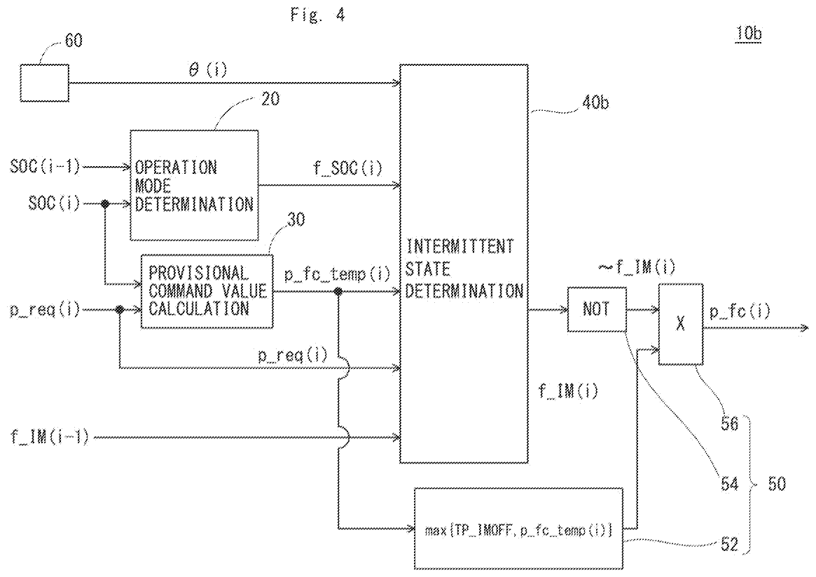

FIG. 4 illustrates a block diagram of a power generation control device according to a second embodiment of the present invention. In FIG. 4, a power generation.control device 10b is used for power generation control of a fuel cell system including a fuel cell (FC) (not shown) that generates power and a secondary battery (BAT) (not shown) that stores surplus power (including regenerative energy), and includes an operation mode determination means 20, a provisional command value calculation means 30, an intermittent state determination means 40b, a power generation command value calculation means 50, and a coverage factor calculation means 60.

### 3.1. Operation Mode Determination Means

The operation mode determination means 20 is a means that determines an operation mode f_SOC(i) of the BAT based on the state of charge SOC(i−1) of the BAT at time (i−1) and the state of charge SOC(i) of the BAT at time i. Since details of the operation mode determination means 20 are the same as those in the first embodiment, description thereof is omitted.

### 3.2. Provisional Command Value Calculation Means

The provisional command value calculation means 30 is a means that determines a power generation provisional command value p_fc_temp(i) of the FC at time i so as to maximize efficiency of the fuel cell system based on the system required power p_req(i) at time i and the state of charge SOC(i) of the BAT at time i. Since details of the provisional command value calculation means 30 are the same as those in the first embodiment, description thereof is omitted.

### 3.3. Intermittent State Determination Means

The intermittent state determination means 40b is a means that determines an intermittent ON/OFF state f_IM(i) of the FC at time i such that switching of the intermittent state of the fuel cell is not continuous based on the operation mode f_SOC(i) of the BAT, the power generation provisional command value p_fc_temp(i), the system renuired power p_req(i) at time i, intermittent ON/OFF state (f_IM(i−1)) of the FC at time (i−1), and a ratio (coverage factor θ(i)) of an oxide film on a fuel cell cathode catalyst at time i.

The intermittent state determination means 40b further includes a threshold changing means that changes the intermittent OFF threshold TP_IMOFF and/or the intermittent ON threshold TP_IMON using the coverage factor θ(i). The intermittent state determination means 40b is different in this point from the intermittent state determination means 40a according to the first embodiment. The coverage factor calculation means and the threshold changing means are described in detail later.

Since other points on the intermittent state determination means 40b are the same as those of the intermittent state determination means 40a in the first embodiment, description thereof is omitted.

### 3.4. Power Generation Command Value Calculation Means

The power generation command value calculation means 50 is a means that stops (OFF) the FC when intermittent ON is determined at time i, and outputs the larger one, as the power generation command value p_fc(i) for the FC at time i, between the p_fc_temp(i) and the intermittent OFF threshold TP_IMOFF when intermittent OFF is determined at time i. In FIG. 4, the power generation command value calculation means 50 includes a power limiting circuit 52, a NOT circuit 54, and a multiplier circuit 56. Since details of the power generation command value calculation means 50 are the same as those in the first embodiment, description thereof is omitted.

### 3.5. Coverage Factor Calculation Means

The coverage factor calculation means 60 is a means that calculates a ratio (coverage factor θ(i)) of the oxide film on the fuel cell cathode catalyst at time i.

If the cathode catalyst is exposed to a high potential, components of the cathode catalyst are easily eluted. On the other hand, if the cathode catalyst is exposed to a high potential, an oxide film is formed on the surface of the cathode catalyst, and elution of the components of the cathode catalyst is suppressed. However, since the oxide film is formed at a low rate, if the cathode potential varies abruptly, formation of the oxide film is delayed, and the components of the cathode catalyst are likely to be eluted.

On the other hand, if the θ(i) is sequentially calculated and the intermittent OFF threshold TP_IMOFF and/or the intermittent ON threshold TP_IMON is changed according to the θ(i), the cathode catalyst can be suppressed from being exposed to a high potential before the oxide film is sufficiently formed. As a result, deterioration or the catalyst caused by repeated potential variations can be suppressed.

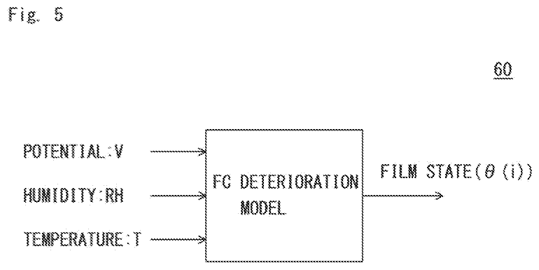

Any calculation means can be used as the coverage factor calculation means 60 as long as the calculation means can calculate the θ(i). FIG. 5 illustrates a block diagram of an exemplary coverage factor calculation means. In FIG. 5, the coverage factor calculation means 60 is a means that calculates the θ(i) based on potential V, humidity RH, and temperature T. In this case, “potential V” refers to cell potential V_{cell} of the FC or catalyst potential V_{cat}. The cell potential (V_{cell}) refers to a potential obtained by adding a potential caused by internal resistance to the catalyst potential. The catalyst potential (V_{cat}) refers to potential of a cathode catalyst layer.

The θ(i) can be calculated using V, RH, and T based on a catalyst deterioration model in the fuel cell. A known method (see reference 1) can be used without limitation as a method for calculating the θ(i).

Reference 1: Farling, R. M. and J. P. Meyers, “Kinetic Model of Platinum Dissolution in PEMFCs,” Journal of the Electrochemical Society 150(11), 2003.

### 4. SPECIFIC EXAMPLE OF INTERMITTENT STATE DETERMINATION MEANS (2)

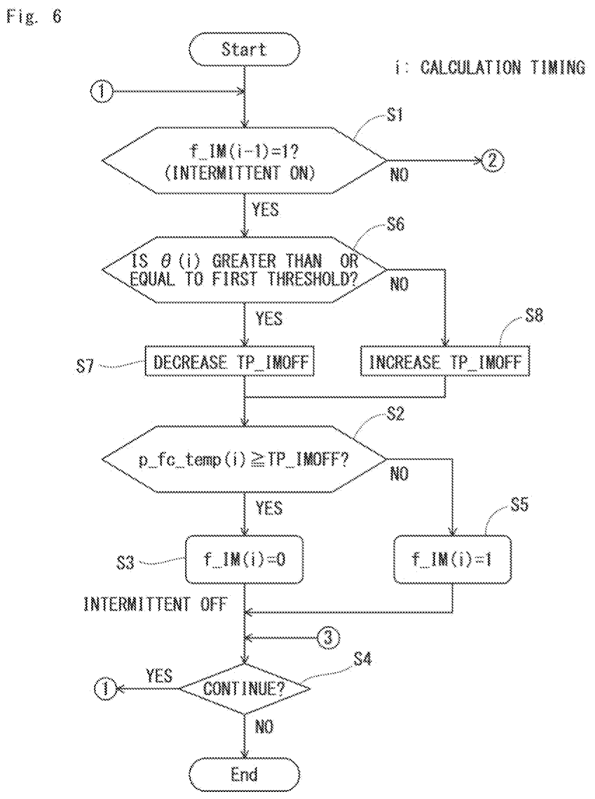

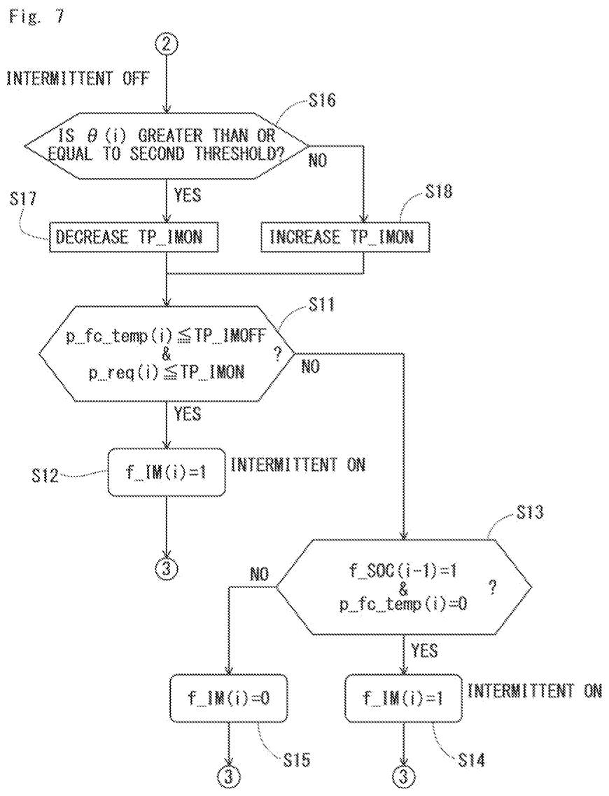

FIG. 6 illustrates a flowchart of a process by the intermittent state determination means according to the second embodiment of the present invention. FIG. 7 illustrates a continuation of the flowchart of FIG. 6. The intermittent state determination means of the second embodiment further includes a threshold changing means that uses the coverage factor θ(i) to change the intermittent OFF threshold TP_IMOFF and the intermittent ON threshold TP_IMON. The intermittent state determination means is different in this point from that of the first embodiment.

### 4.1. First Threshold Changing Means and Second Threshold Changing Means

First, in S1, it is determined whether the FC is in the intermittent ON state (FC stopped state) at time (i−1), i.e., whether the flag f_IM(i−1) representing the intermittent ON/OFF state of the FC at time (i−1) is 1. If the FC is in the intermittent ON state at time (i−1) (S1: YES), the process proceeds to S6.

In S6, it is determined whether the θ(i) is greater than or equal to a first threshold.

The term “first threshold” refers to the threshold of the θ(i) for changing the intermittent OFF threshold TP_IMOFF. An optimum value can be selected without limitation as the value of the first threshold according to a purpose. The value of the first threshold can be set, for example, by experimentally determining a state in which an oxide film is formed and thus the catalyst is no longer eluted.

In general, when the θ(i) is relatively large (i.e., when the oxide film is sufficiently formed), catalyst components are less likely to be eluted even if the catalyst is exposed to a high potential. Hence, when the θ(i) is equal to or larger than the first threshold (S6: YES), the process proceeds to S7, and the TP_IMOFF is decreased (first threshold changing means). This corresponds to the following operation: when the θ(i) is relatively large, the intermittent ON state is easily switched to the intermittent OFF state (FC operating state) even if the p_fc_temp(i) is relatively small, and the FC is operated at an efficient light load (high potential) operating point.

On the other hand, when the θ(i) is relatively small (i.e., when the oxide film is not sufficiently formed), the catalyst components tend to be eluted if the catalyst is exposed to a high potential. Hence, if the θ(i) is smaller than the first threshold (S6: NO), the process proceeds to S8, and the TP_IMOFF is increased (second threshold changing means). This corresponds to the following operation: when the θ(i) is small, the intermittent ON state is made less likely to be switched to the intermittent OFF state (FC operating state), and when the state is switched to the intermittent OFF state, the FC is operated at a high load (low potential) operating point to prevent the catalyst components from being eluted.

After changing the TP_IMOFF in S7 or S8, the process proceeds to S2. Thereafter, steps S2 to S4 are repeated as in the first embodiment. Since details of S2 to S4 are the same as those for the intermittent state determination means of the first embodiment, description thereof is omitted. The power generation control device 10b of the second embodiment may include the first threshold changing means (S7) and/or the second threshold changing means (S8).

### 4.2. Third Threshold Changing Means and Fourth Threshold Changing Means

In S1, if the FC is not in the intermittent ON state at time (i−1) (S1: NO), the process proceeds to S16 in FIG. 7

In S16, it is determined whether the θ(i) is equal to or larger than the second threshold.

The term “second threshold” refers to the threshold of the θ(i) for changing the intermittent ON threshold TP_IMON. An optimum value can be selected without limitation as the value of the second threshold according to a purpose. The value of the second threshold can be set, for example, by experimentally determining a state in which the oxide film is formed, and the catalyst is no longer eluted.

In general, when the θ(i) is relatively large (that is, when the oxide film is sufficiently formed), catalyst components are less likely to be eluted even if the catalyst is exposed to a high potential. Hence, when the θ(i) is equal to or larger than the second threshold (S16: YES), the process proceeds to S17, and the TP_IMON is decreased (third threshold changing means). This corresponds to the following operation: when the θ(i) is large, the intermittent OFF state is made less likely to be switched to the intermittent ON state (FC stopped state) even if the p_req(i) is relatively small, and the FC is continuously operated while being in the efficient light load (high potential) state.

On the other hand, when the θ(i) is relatively small (that is, when the oxide film is not sufficiently formed), the catalyst components tend to be eluted if the catalyst is exposed to a high potential. Hence, when the θ(i) is smaller than the second threshold (S16: NO), the process proceeds to S18, and the TP_IMON is increased (fourth threshold changing means). This corresponds to the following operation: when the θ(i) is small, the intermittent OFF state is made less likely to be switched to the intermittent ON state (FC stopped state), and the FC is operated at a high load (low potential) operating point, so that the oxide film is formed on a catalyst surface.

After changing the TP_IMON in S17 or S18, the process proceeds to S11. Thereafter, steps S11 to S15 are repeated as in the first embodiment. Since details of S11 to S15 are the same as those for the intermittent state determination means of the first embodiment, description thereof is omitted. The power generation control device 10b of the second embodiment may include the third threshold changing means (S17) and/or the fourth threshold changing means (S18) in addition to or in place of the first threshold changing means (S7) and/or the second threshold changing means (S8).

### 5. SPECIFIC EXAMPLE OF PROVISIONAL COMMAND VALUE CALCULATION MEANS

The provisional command value calculation means that achieves the above-described functions includes various means. Of these, the provisional command value calculation means preferably includes a means that substitutes the p_req(i) for a later-described composite function f(x) (including a function obtained by mathematically transforming the f(x)), calculates a value of x when the composite function f(x) is minimum, and determines the value as the p_fc_temp(i). A method for determining the p_fc_temp(i) using the composite function f(x) is described below.

### 5.1. Composite Function

In a hybrid system with the FC and the BAT, the system required power p_req(i) at time i must be supplied by the FC and the BAT at any time so as to be equal to the sum of the net output p_fc(i) of the FC at time i and the net output p_bat(i) of the BAT at time i. The following formula (1) shows a relationship between them.

p_req(i)=p_fc(i)+p_bat(i) (1)

In the present invention, under such a condition, output of the FC is determined by minimizing a composite function given by the sum of
(a) a fuel consumption function of the FC (a function representing a relationship between FC output and fuel consumption), which has the effect of suppressing the fuel consumption of FC by minimizing,
(b) a quadratic function of BAT output, which has the effect of suppressing the BAT output by minimizing, and
(c) a linear function of the BAT output, which has the effect of maintaining the state of charge SOC of the BAT at the SOC center (SOC_{c}) by minimizing.

The composite function f(x) is specifically expressed by the following formula (2).

f(x)=fuel(x)+γ(p_req(i)−x)²+λ·k(p_req(i)−x) (2)
where
fuel(x) is a fuel consumption function of the FC,
x is net output of the FC (=p_fc(i)),
γ(>0) is a first control parameter and is correlated with the degree of deterioration of the BAT or of both the BAT and the FC,
λ is a second control parameter and is correlated with the state of charge (SOC) of the BAT, and
k(<0) is a BAT-specific negative constant.

### 5.2. Fuel Consumption Function

### 5.2.1. Overview

The first term on the right-hand side of the formula (2) is the fuel consumption function fuel(x), which expresses a relationship between FC net output x (=p_fc(i)) and fuel consumption. There is a positive correlation between the p_fc(i) and the fuel consumption, that is, the larger p_fc(i) is, the more fuel is consumed. In other words, minimizing the first term corresponds to reducing the fuel consumption.

### 5.2.2. Approximation by Quadratic Function

A shape of the fuel(x) differs depending on specifications of the FC, and generally cannot be expressed by a simple function. Hence, in the case of obtaining the minimum value of the f(x), when calculation accuracy is pursued, the optimum solution is preferably obtained by repeated calculation such as, for example, the gradient method.

On the other hand, the fuel(x) may be approximated by a quadratic function of x. In this case, since the calculation of the minimum value of the f(x) can be obtained by a simple calculation, calculation time can be shortened.

The following formula (9) shows a fuel consumption function approximated by a quadratic function.

fuel(x)=a·x²+b·x+c (9)
where
fuel(x) is a fuel consumption function of the FC,
x is net output of the FC (=p_fc(i)),
a(>0), b, and c are each a coefficient obtained by fitting a relationship between true fuel consumption characteristics of the FC and x.

Examples of the fitting method include the least squares method.

Since the coefficient a is a positive value, the f(x) becomes a quadratic convex function by substituting the formula (9) into the formula (2). Hence, the minimum value of the f(x) is uniquely obtained as a solution of the following formula (10).

df(x)/dx=0 (10)

The optimal solution x* (=p_fc_temp(i)) is therefore given by the following formula (11).

x*=(λ·k+2γ·p_req(i)−b)/2(a+γ) (11)

Using the formula (11) slightly deteriorates calculation accuracy, but advantageously reduces a calculation load because repeated optimization calculations can be avoided.

### 5.3. Second Term (Quadratic Function of Battery Output)

### 5.3.1. Overview

The second term in the formula (2) includes a function obtained by multiplying the square of the BAT output by the first control parameter γ. The parameter γ is a function of the FC deterioration index and the BAT deterioration index, and takes a positive value at any time. The γ is a coefficient that takes a larger value as the BAT is more deteriorated and/or as the FC is less deteriorated.

### 5.3.2. First Control Parameter γ

In order to determine the second term, it is necessary to know the value of the first control parameter γ. Specifically, γ can be calculated from the following formulas (3) and (4).

γ=γ₀+Δγ (3)

Δγ=α/Det_{FC}+β·Det_{BAT} (4)
where
γ₀ is a nominal value (constant),
Det_{FC} is the deterioration index of the FC,
Det_{BAT} is the deterioration index of the BAT,
α is a conversion factor (constant) of the reciprocal of Det_{FC}, and has a positive value, and
β is a conversion factor (constant) of Det_{BAT}.

The Det_{FC} is an index indicating that the FC is more deteriorated with an increase in a value of the Det_{FC}. The magnitude of the Det_{FC} depends on operating history of the FC. Examples of the operation history affecting the Det_{FC} includes history of current/voltage of the FC, voltage change rate over time, frequency for each voltage change rate over time, and frequency for each voltage.

The Det_{BAT} is an index indicating that the BAT is more deteriorated with an increase in a value of the Det_{BAT}. The Det_{BAT} depends on operating history of the BAT. Examples of the operation history affecting the Det_{BAT} include temperature of the BAT, history of current of the BAT, and history of the state of charge of the BAT.

The respective constants γ₀, α, and β are uniquely determined when the specifications of the FC and/or the BAT are determined. Hence, if the Det_{FC} and the Det_{BAT} are known, γ is uniquely determined. An optimum method can be selected without limitation as the method for calculating the Det_{FC} and the Det_{BAT} according to a purpose.

Examples of the method for calculating the Det_{FC} and the Det_{BAT} include:
(a) a method of storing actual operating history of the FC and/or the BAT and estimating γ from the actual operating history;
(b) a method of, based on a parameter (for example, age) other than the operation histories of the FC and the BAT, estimating γ from a map that gives γ to the parameter; and
(c) a method of estimating γ from deviation between a reference operating point (I-V) and a measured operating point.

Of these, the method of estimating γ based on the actual operating history is preferable as the method for calculating γ, because progress of deterioration of the FC and/or the BAT is accurately estimated thereby. Specifically, γ is preferably calculated by the following method.

(1) A database (A) showing a relationship between the FC operation history and the FC deterioration index Det_{FC} is stored in advance in a memory, and Det_{FC} corresponding to the actual FC operation history is read from the database (A), and the read Det_{FC} is stored in the memory (procedure E1).

(2) A database (B) showing a relationship between the BAT operation history and the BAT deterioration index Det_{BAT} stored in advance in a memory, and Det_{BAT} corresponding to the actual operation history of the BAT is read from the database (B), and the read Det_{BAT} is stored in the memory (procedure E2).

(3) γ is calculated by substituting the relevant Det_{FC} and Det_{BAT} into the above formulas (3) and (4), respectively, and the calculated γ is stored in the memory (procedure E3).

### 5.4. Third Term (Linear Function of BAT Output)

### 5.4.1. Overview

The third term in the formula (2) includes a function obtained by multiplying the BAT output by the second control parameter λ and the constant k. The parameter λ is a function of the state of charge (SOC) of the BAT, and may take a positive value or a negative value. In addition, λ is a coefficient the absolute value of which is larger with an increase in deviation of the SOC from the center (SOC_{c}) of the state of charge of the BAT.

In the formula, k is a BAT-specific negative value. When λ is positive, therefore, the third term shows an up-right straight line. When λ is positive, minimizing the third term corresponds to decreasing an output sharing ratio of the FC while increasing an output sharing ratio of the BAT.

Conversely, when λ is negative, the third term shows a straight line down to the right. When λ is negative, minimizing the third term corresponds to increasing the output sharing ratio of the FC while decreasing the output sharing ratio of the BAT.

Further, since λ is correlated with the SOC_{c}, minimizing the third term corresponds to charging or discharging the BAT such that the SOC is closer to the SOC_{c}.

### 5.4.2. Calculation Method of λ

The second control parameter λ can be calculated by various methods.

### A. First Method

A first method is to calculate λ based on the following formulas (5) and (6).

λ=λ₀+g·ΔSOC (5)

ΔSOC=SOC−SOC_{c} (6)
where
λ₀ is a nominal value (constant),
g is a conversion factor (constant) of ΔSOC or a function obtained by multiplying the conversion factor of the ΔSOC by a smoothing filter (low-pass filter), and
SOC_{c} is the center of the state of charge SOC of the BAT.

The respective constants λ₀ and SOC_{c} are uniquely determined when the specification of the BAT is determined. In addition, g is a positive constant that can be arbitrarily set according to a purpose. As the value of g increases, a slight difference in ΔSOC appears as a large difference in λ. Hence, if the SOC that changes from moment to moment is known, λ can be known.

Specifically, in the first method, λ is preferably calculated by the following method.
(1) The state of charge (SOC) of the BAT is detected and stored in a memory (procedure F1).
(2) λ is calculated by substituting the SOC into the formulas (5) and (6), and the calculated λ is stored in the memory (procedure F2).

### B. Second Method

The second method is to calculate λ based on formulas (7) and (8).

λ=λ₀+sign(ΔSOC)·h(ΔSOC) (7)

h(ΔSOC)=h(SOC−SOC_{c}) (8)
where
λ₀ is a nominal value (constant),
sign(x) is a sign function, and
h(x) is a linearly symmetric non-linear function with the axis of symmetry at the SOC_{c}, which is zero near the center (SOC_{c}) of the state of charge of the BAT and increases exponentially as SOC increases or decreases from the SOC_{c}.

The sign(ΔSOC) represents a positive or negative sign of the ΔSOC. The h(ΔSOC) is an arbitrary nonlinear function that takes a large value near the respective upper and lower limits of the SOC and a small value near the SOC_{c}. The h(ΔSOC) is not limited and may be an even order function such as a quadratic function or a quartic function, or a polynomial function showing even function characteristics.

The first method has an advantage of low computational load because λ is expressed as a linear function of the SOC. In the first method, however, even if the SOC deviates slightly from the SOC_{c}, λ will have a large value. As a result, charge and discharge of the BAT may be repeated more than necessary.

In contrast, the second method maintains λ at a relatively small value when the SOC is around the SOC_{c}. In the second method, therefore, charge and discharge of the BAT are not repeated more than necessary.

In the second method, specifically, λ is preferably calculated by the following method.
(1) The state of charge (SOC) of the BAT is detected and stored in a memory (procedure F1).
(2) λ is calculated by substituting the SOC into the formulas (7) and (8), and the calculated λ is stored in the memory (procedure F3).

### 6. EFFECTS

If intermittent control of the fuel cell is performed based only on the system required power p_req(i) at time i, switching frequency of the intermittent state increases. As a result, the cathode catalyst is repeatedly exposed to potential variations, leading to progressive catalyst deterioration.

In contrast, when the system required power p_req(i) varies, switching of the intermittent ON/OFF state is performed at an optimal timing such that switching of the intermittent state of the fuel cell is not continuous, making it possible to minimize deterioration of the cathode catalyst.

In the case of power distribution between the fuel cell and the secondary battery, if power is distributed to maximize the efficiency of the fuel cell system (i.e., the power generation provisional command value p_fc_temp(i) is determined to maximize the efficiency of the fuel cell system), reduction in fuel efficiency can also be reduced. Further, when the SOC state is also used to control the intermittent ON/OFF, the contradiction of deterioration of SOC controllability is also eliminated, and the adverse effect of the reduction in fuel efficiency can be eliminated.

In the case of operating the fuel cell, if the larger one of the power generation provisional command value p_fc_temp(i) and the intermittent OFF threshold value TP_IMOFF is selected as the power generation command value p_fc(i) of the fuel cell at time i, the fuel cell is maintained in a high load (low potential) state for a relatively long time. As a result, catalyst deterioration can be suppressed.

Further, the intermittent OFF threshold TP_IMOFF and/or the intermittent ON threshold TP_IMON are changed according to the coverage factor θ(i) of the cathode catalyst, making it possible to perform low load (high potential) operation with priority to efficiency in the case of large θ(i), and high-load (low-potential) operation with priority to protection of the catalyst in the case of small θ(i). As a result, it is possible to achieve improvement in efficiency together with superession of deterioration.

### EXAMPLE

### Example 1 and Comparative Example 1

### 1. Test Method

In the fuel cell system including the fuel cell and the secondary battery, when the system required power p_req(i) varies irregularly, the temporal changes in the FC generated power P_{FC} and the FC cell voltage V_{FC} are determined by simulation.

As the control method of the fuel cell system, the following method is used:
(a) a method of performing intermittent control of the fuel cell based only on the system required power p_req(i) at time i (comparative example 1); or
(b) a method of performing intermittent control of the fuel cell according to the flowcharts of FIGS. 2 and 3 (The example 1).

### 2. Results

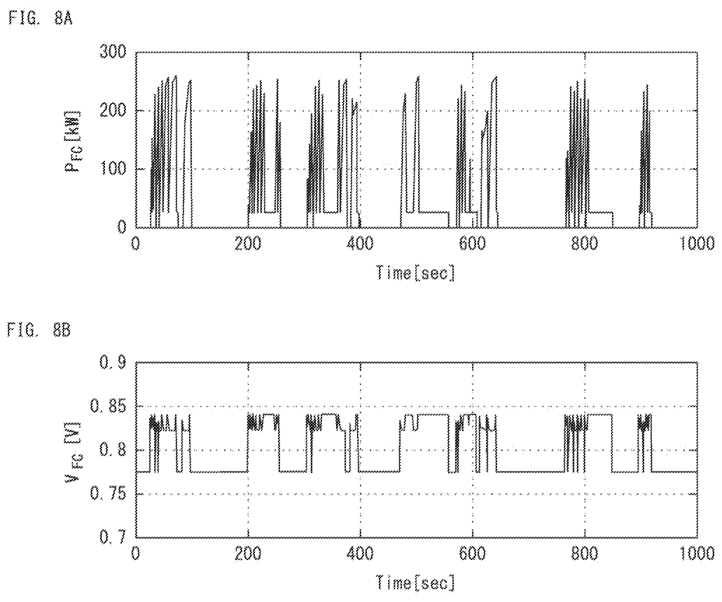

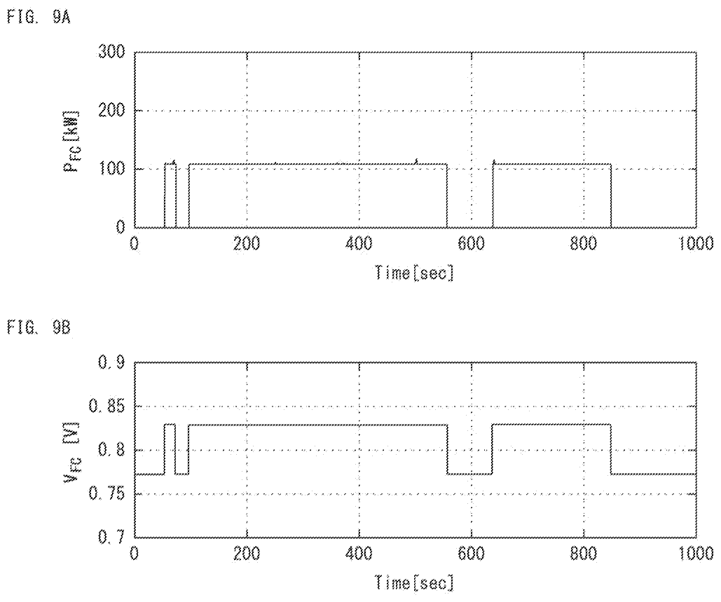

FIGS. 8A and 8B show temporal changes in FC generated power P_{FC} and FC cell voltage V_{FC}, respectively, according to the control method of the comparative example 1. FIGS. 9A and 9B show temporal changes in FC generated power P_{FC} and FC cell voltage V_{FC}, respectively, according to the control method of the example 1.

In the comparative example 1, when the FC generated power P_{FC} is changed, the FC cell voltage V_{FC} varies accordingly. On the other hand, in the example 1, variations in the FC generated power P_{FC} are steadily reduced, and the number of potential variations is also reduced. Deterioration of the FC is caused by a FC potential value and potential variations. FIGS. 8A and 8B and FIGS. 9A and 9B show that the catalyst deterioration can be controlled by the control method of the present invention.

Although one embodiment of the present invention has been described in detail hereinbefore, the present invention is not limited to the embodiment, and various modifications can be made without departing from the gist of the present invention.

The power generation control device according to the present invention can be used for power generation control of a hybrid vehicle including a fuel cell and a battery.

1. A power generation control device used for power generation control of a fuel cell system including a fuel cell (FC) that generates power and a secondary battery (BAT) that stores surplus power, the power generation control device comprising:
an operation mode determination means that determines an operation mode f_SOC(i) of the BAT based on a state of charge SOC(i−1) of the BAT at time (i−1) and a state of charge SOC(i) of the BAT at time i;
a provisional command value calculation means that determines a power generation provisional command value p_fc_temp(i) of the FC at the time i so as to maximize efficiency of the fuel cell system based on system required power p_req(i) at the time i and the state of charge SOC(i) of the BAT at the time i;
an intermittent state determination means that determines an intermittent ON/OFF state f_IM(i) of the FC at the time i to avoid continuous switching of the intermittent state of the FC based on the operation mode f_SOC(i) of the BAT, the p_fc_temp(i), the p_req(i) at the time i, and an intermittent ON/OFF state f_IM(i−1) of the FC at the time (i−1); and
a power generation command value calculation means that stops (OFF) the FC when intermittent ON is determined at the time i, and outputs a larger one, as a power generation command value p_fc(i) for the FC at the time i, between the p_fc_temp(i) and an intermittent OFF threshold TP_IMOFF when intermittent OFF is determined at the time i.

2. The power generation control device according to claim 1, wherein the provisional command value calculation means includes a means that substitutes the p_req(i) for a composite function f(x) (including a function obtained by mathematically transforming the f(x)) expressed by the following formula (2), calculates a value of x when the composite function f(x) is minimum, and determines the value as the p_fc_temp(i),
f(x)=fuel(x)+γ(p_req(i)−x)²+λ·k(p_req(i)−x) (2)
where
fuel(x) is a fuel consumption function of the FC,
x is net output of the FC,
γ(>0) is a first control parameter and is correlated with the degree of deterioration of the BAT or of both the BAT and the FC,
λ is a second control parameter and is correlated with the state of charge (SOC) of the BAT, and
k(<0) is a BAT-specific negative constant.

3. The power generation control device according to claim 1, wherein the provisional command value calculation means includes a means that determines the power generation provisional command value p_fc_temp(i) of the FC at the time i to allow the state of charge of the BAT to fall between the upper SOC limit and the lower SOC limit.

4. The power generation control device according to claim 1, wherein the intermittent state determination means includes:
a first switching means that, when the FC is in an intermittent ON state at the time (i−1) and when the p_fc_temp(i) is equal to or larger than an intermittent OFF threshold (TP_IMOFF), switches the intermittent ON state to an intermittent OFF state at the time i;
a second switching means that, when the FC is in the intermittent OFF state at the time (i−1) and when the p_fc_temp(i) is smaller than or equal to the TP_IMOFF and the p_req(i) is smaller than or equal to an intermittent ON threshold (TP_IMON), switches the intermittent OFF state to the intermittent ON state at the time i; and
a third switching means that, when the p_fc_temp(i) is more than the TP_IMOFF and/or when the p_req(i) is more than the TP_IMON, and when the BAT is in a discharge mode at the time (i−1) and the p_fc_temp(i) is equal to or smaller than an output lower limit (LL) of the FC, switches the intermittent OFF state to the intermittent ON state at the time i.

5. The power generation control device according to claim 4, wherein the TP_IMON is capable of taking a negative value.

6. The power generation control device according to claim 1, further comprising a coverage factor calculation means that calculates a ratio (coverage factor θ(i)) of an oxide film on a fuel cell cathode catalyst at the time i,
wherein the intermittent state determination means includes a threshold changing means that changes the intermittent OFF threshold TP_IMOFF and/or an intermittent ON threshold TP_IMON using the coverage factor θ(i).

7. The power generation control device according to claim 6, wherein the coverage factor calculation means includes a means that calculates the θ(i) based on cell potential V_{cell} or catalyst potential V_{cat} of the FC, humidity RH, and temperature T.

8. The power generation control device according to claim 6, wherein the threshold changing means comprises at least one means selected from a group consisting of:
a first threshold changing means that, when the FC is in an intermittent ON state at the time (i−1), and when the θ(i) is equal to or larger than a first threshold, decreases the TP_IMOFF;
a second threshold changing means that, when the FC is in the intermittent ON state at the time (i−1), and when the θ(i) is smaller than the first threshold, increases the TP_IMOFF;
a third threshold changing means that, when the FC is in an intermittent OFF state at the time (i−1), and when the θ(i) is equal to or larger than a second threshold, decreases the TP_IMON; and
a fourth threshold changing means that, when the FC is in the intermittent OFF state at the time (i−1), and when the θ(i) is smaller than the second threshold, increases the TP_IMON.
